(19) United States
(12) Patent Application Publication
(10) Pub. No.: US 2023/0114641 A1
(43) Pub. Date: Apr. 13, 2023

(54) METHOD AND PRODUCTION PLANT FOR PRODUCING NITRIC ACID

(71) Applicant: Messer SE & Co. KGaA, Bad Soden (DE)

(72) Inventors: Joachim Rohovec, Leobersdorf (AT); Nina Van Gellecom, Mettmann (DE)

(73) Assignee: Messer SE & Co. KGaA, Bad Soden (DE)

(21) Appl. No.: 17/906,928

(22) PCT Filed: Mar. 17, 2021
(86) PCT No.: PCT/EP2021/056873

§ 371 Date: Sep. 21, 2022

(30) Foreign Application Priority Data
Mar. 27, 2020 (DE) 10 2020 002 008.9

(51) Int. Cl. C01B 21/40; B01J 10/00; B01J 19/24

(52) U.S. Cl. CPC C01B 21/40; B01J 10/00; B01J 19/245

(57) ABSTRACT

In a process for preparing nitric acid, nitrogen oxides are first produced in an ammonia combustion plant and cooled in a condenser to form a nitric acid-containing solution. The nitric acid-containing solution is then supplied to at least one absorption tower in which the nitrogen oxides are brought into contact with water and oxygen, wherein the nitrogen-containing gas mixture reacts with the water and the oxygen at least in part to form an aqueous nitric acid-containing solution which accumulates at the base of the absorption tower and is then compressed and recycled via a conduit back into the absorption tower. In order to minimize the concentration of nitrogen oxides in the offgas from such a plant and to increase the efficiency of the process, the invention proposes injecting ozone into a connection conduit which leads from the condenser to a first absorption tower and conducts the nitric acid-containing solution.

### CROSS-REFERENCE TO RELATED APPLICATIONS

The present application is the U.S. national stage application of international application PCT/EP2021/056873 filed Mar. 17, 2021, which international application was published on Sep. 30, 2021, as International Publication WO 2021/191031 A1. The international application claims priority to German Patent Application No. 10 2020 002 008.9 filed Mar. 27, 2020.

### FIELD

The present disclosure relates to a process for preparing nitric acid. The disclosure further relates to a production plant for preparing nitric acid.

### BRIEF DISCLOSURE

The invention thus relates to a process and a plant for the industrial preparation of nitric acid in which a multistage catalytic ammonia oxidation process (Ostwald process) is employed. In the first step, ammonia and oxygen are reacted in a reactor (hereinafter also referred to as “ammonia combustion unit”) over a gauze catalyst usually consisting of noble metals, for example platinum-rhodium, to give nitrogen monoxide and steam:

4NH₃+5O₂Δ4NO+6H₂O (1)

This reaction is conducted at high temperatures, for example at 900° C. In general, the operation proceeds using a superstoichiometric amount of air/oxygen in order to prevent an explosive mixture from forming and in order to provide additional oxygen for downstream oxidation reactions. The reactor output is then cooled in a condenser to a temperature at which some of the components present in the process gas stream condense out. Some of the nitrogen monoxide reacts with water and oxygen to form an aqueous nitric acid-containing solution which also further contains nitrogen oxides, especially nitrogen monoxide. The remaining gas mixture that does not go into solution is supplied to an absorption tower (column) in which some of the gaseous nitrogen monoxide is oxidized with oxygen supplied in the form of atmospheric oxygen or in the form of pure oxygen, to give nitrogen dioxide and the dimer thereof dinitrogen tetraoxide, these then being reacted with water to give nitric acid:

2NO+O₂Δ2NO₂ΔN₂O₄ (2)

3NO₂+H₂OΔ2HNO₃+NO (3)

N₂O₄+H₂OΔHNO₃+HNO₂ (4)

2HNO₂ΔHNO₃+2NO+H₂O (5)

2N₂O₄+O₂+2H₂OΔ4HNO₃ (6)

The water/the nitric acid-containing solution (weak acid) that forms passes through the absorption tower typically in countercurrent to the rising gas stream. The liquid phase, which previously formed in the condenser, is usually supplied to one of the lower trays of the column The nitric acid accumulates at the base of the absorption tower in an aqueous solution. This nitric acid is conducted to the top of the bleaching column and fed there. In countercurrent thereto, air is supplied to the bleaching column in order to strip the nitrous gases still present in the solution. In many cases, two or more absorption towers are also connected in series, with the gas stream and the nitric acid passing through the series of absorption towers in countercurrent. In order to increase the solubility of the nitrous gases, the absorption tower/the absorption towers is/are operated at a relatively high pressure of from 1 to 15 bar(g). In plants in which the absorption towers operate at a comparatively low pressure of from 1 to 5 bar(g) (low- and medium-pressure plants), the proportion of nitrous offgases in the offgas is relatively high. While applying higher pressures does lead to a reduction in the residual content of nitrogen oxides in the offgas, this is associated with considerable additional costs for the compression and for the design of the plant components to be correspondingly suitable for higher pressures.

### BACKGROUND

In order to increase the efficiency of this process, attempts have already been made to increase the oxygen partial pressure by introducing additional oxygen at various points, to promote the reaction towards the products and hence to reduce the proportion of nitrous gases in the offgas. For example, in EP 0 799 794 A1, EP 1 013 604 B1 and EP 2 953 894 A1 propose supplying oxygen or an oxygen-enriched gas into the nitric acid production process outlined above to increase the efficiency of the process, improve the quality of the nitric acid produced or reduce the formation of undesired NOx gases.

It is also known to employ ozone in nitric acid production. For example, WO 2019/036771 A1, U.S. Pat. Nos 5,206,002 A and 6,231,824 B1 propose employing ozone for the oxidation of NOₓ in the offgases of a nitric acid production plant. WO 2013/028 668 A2 describes a process for removing nitrous components from crude nitric acid in order to reduce the proportions of NOₓ in the offgas. The process includes a process step in which gaseous ozone is introduced directly into the absorption tower of a nitric acid production plant. In the spaces between the trays of the absorption tower, nitrogen oxides present there are intended to react with the ozone to give N₂O₅, which is then reacted with water to give nitric acid.

### SUMMARY

In spite of such improvements, it is possible to achieve a further efficiency increase and process optimization of the nitric acid production process described at the outset, which is at the same time the object of the present invention.

This object is achieved by a process having the features of claim 1 and by a production plant for preparing nitric acid having the features of claim 7. Advantageous configurations of the invention are specified in the dependent claims.

The process according to the invention for preparing nitric acid is therefore characterized in that ozone is introduced into the aqueous, nitric acid-containing solution that is formed during the condensation of the reaction products from the ammonia combustion in the condenser. The ozone is introduced in particular by supplying an ozone-containing gas, especially an ozone/oxygen mixture. The ozone dissolves at least partially in the nitric acid-containing solution and passes together with the latter into the absorption tower.

The invention proceeds from the basic concept that the nitric acid-containing solution from the condenser also contains nitrogen oxides (essentially nitrogen monoxide) and nitrous acid which are oxidized by the reaction with ozone.

2NO₂+O₃ΔNO₂+O₂ (7)

2NO+3O₃+H₂OΔ2HNO₃+3O₂ (8)

2NO₂+O₃+H₂OΔ2HNO₃+O₂ (9)

HNO₂+O₃ΔHNO₃+O₂ (10)

The introduction per the invention of ozone as early as into the connection conduit leading from the condenser to the absorption tower leads, as a result of the high concentration of substances to be oxidized and relatively long residence time of the ozone in the solution, to a considerable reduction in NO_{X} constituents in the offgas. Moreover, ozone and/or oxygen can additionally be supplied in other sections of the production process in order to yet further reduce the NO_{X} concentration and increase the efficiency of the process.

The ozone is preferably generated on site from oxygen in an ozonizer and supplied directly, possibly together with any oxygen still present, with at least the pressure required for the introduction. It is furthermore advantageous to introduce the ozone into the nitric acid-containing solution conducted through the connection conduit with a minimal temperature of preferably below 10° C., particularly preferably below 0° C.

The process in particular encompasses those application scenarios in which only one absorption tower is present, in which the “first absorption tower” is thus the only absorption tower of the production plant. However, the invention is in no way limited to such application scenarios; rather an arrangement made up of two or more absorption towers may also be used. In this case, the nitrogen oxide-containing process gas mixture, in a manner known per se, flows through the first absorption tower and is supplied at least to a second absorption tower and brought into contact there with water or weak acid in countercurrent. The nitrogen oxide-containing gas mixture reacts at least in part to form an aqueous, nitric acid-containing solution, or weak acid, which accumulates at the base of the second absorption tower and from there is supplied by means of a conveying device to an upper region of the first absorption tower via a riser conduit. In a preferred embodiment of the invention, ozone or oxygen is also introduced into this riser conduit in order to cause the substances dissolved in the weak acid to react with oxidizing agents.

Likewise conceivable are configurations in which nitric acid-containing solution is withdrawn from the base of the first absorption tower in order to be conveyed via a conveying conduit into the bleaching column and/or into a section of the first absorption tower that is higher relative to the base. A once-again advantageous configuration of the invention provides for ozone and/or oxygen to also be introduced into the nitric acid-containing solution conducted through this/these conveying conduit(s).

The “oxygen” used in the aforementioned cases is preferably oxygen having a purity of at least 95% by volume; however, the oxygen may also be supplied in the form of air or as another oxygen-containing gas mixture. The oxygen is supplied to the nitric acid-containing solution in gas form or else in cryogenically liquefied form, where at least in the last-mentioned case care should be taken to ensure that the flow paths are not iced up as a result of the supply of the cryogenic medium. Alternatively, liquid oxygen can be evaporated prior to being supplied to the nitric acid-containing solution. This can be effected in a customary air evaporator, or the cold content of the liquid oxygen is used in another manner, for example for the aforementioned cooling of the reaction products of the ammonia combustion.

Since a higher pressure favors the dissolution of the ozone in the reaction as a whole, the ozone is preferably injected into the system at a point at which a higher pressure prevails in relation to the pressure in the column. Suitable for this purpose in particular is a geodetically lower section of a riser conduit, preferably downstream of a conveying device that is present, since here a comparatively high pressure already prevails on account of the hydrostatic pressure.

Alternatively or in addition to this, it is advantageous for a substream to be branched off from the main stream of the nitric acid-containing solution conducted through the respective conduit, compressed in a bypass conduit to a pressure higher than the pressure in the conduit, and enriched with ozone and/or oxygen. The enriched substream is then recycled to the main stream or injected directly into the absorption tower or into the bleaching column. For example, the pressure of the substream in the bypass conduit is compressed to a value of from 5 to 15 bar, as a result of which the ozone dissolves even more readily. It is furthermore also conceivable in the context of the invention for nitric acid-containing solution to be withdrawn from the condenser or from an absorption tower in batches and treated with ozone under appropriately high pressures in pressurized vessels.

The object of the invention is also achieved by a production plant having the features of claim 7.

A production plant according to the invention for preparing nitric acid comprises an ammonia combustion plant for reacting ammonia with oxygen to give nitrogen oxides and steam, a condenser connected to the ammonia combustion plant for cooling the reaction products from the ammonia combustion plant, in which at least some of the reaction products condense, a first absorption tower arranged downstream of the condenser for scrubbing the gas mixture formed in the condenser with water or with an aqueous solution, at least one connection conduit for supplying a nitric acid-containing solution from the condenser into the first absorption tower, a conveying conduit connecting the first absorption tower to a bleaching column for conveying crude acid, and an ozone supply conduit which is connected to a source for ozone and is connected in terms of flow to the connection conduit running between the condenser and the first absorption tower.

In an advantageous variant of the invention, a bypass conduit branches off from the last-mentioned connection conduit, into which bypass conduit the ozone supply conduit opens and which bypass conduit returns into the connection conduit before the latter opens into the absorption tower or opens into the absorption tower separately from connection conduit.

The ozone supply conduit opens into the connection conduit or the bypass conduit at an introduction device, for example an introduction lance or a venturi nozzle, and thus enables an efficient supply of an ozone-containing gas mixture into the nitric acid-containing solution. The introduction system is preferably suitable for rapidly and intimately mixing the introduced ozone and the nitric acid-containing solution with each another.

If the connection conduit is a riser conduit, the introduction device is preferably arranged in an—as viewed geodetically—lower region of the connection conduit; particularly preferably it is located approximately the height of the base of the first absorption tower. This configuration has the advantage in particular that the hydrostatic pressure of the liquid column in the connection conduit promotes the dissolution of the ozone. It is additionally expedient to introduce the ozone as closely as possible to the start (as viewed in the direction of flow of the solution) of the conduit, since in this way the entire section of the connection conduit and/or of the bypass conduit that adjoins the introduction device is utilized as a reactor carrying out the above-mentioned reaction (6) for producing nitric acid. It is therefore particularly advantageous for additional means for increasing the contact time to be provided, for example an enlarged flow cross section of the conduit or a lengthened conduit.

In a once-again advantageous configuration of the invention, means are provided in the connection conduit and/or the bypass conduit which guarantee a maximal pressure of the nitric acid-containing solution within the region of the conduit into which the ozone supply opens. These are for example a compressor arranged upstream of the mouth of the ozone supply conduit and a pressure reducer arranged downstream of the mouth of the ozone supply conduit, by means of which a pressure is generated in the collection conduit or in the bypass conduit which is at least higher than the hydrostatic pressure in the conduit and for example is 10-15 bar(g).

In the case of a production plant which comprises more than one absorption tower, that is to say in which at least one second absorption tower or two or more second absorption towers is/are connected downstream of the first absorption tower and a riser conduit or two or more riser conduits is/are present which leads/lead from the base of the second or subsequent absorption tower to the headspace of the first absorption tower or of an upstream second absorption tower, a preferred configuration of the invention provides for a supply conduit that is connected in terms of flow with a source for ozone and/or oxygen to open into this/these riser conduit(s) or at least into one or some of these riser conduits, specifically preferably downstream of a conveying device arranged in this/these riser conduit(s), if one is present.

A likewise advantageous configuration of the invention provides for a supply conduit that is connected in terms of flow to a source for ozone and/or oxygen to open into an optionally present riser conduit, which leads from the bottom of the first or a further absorption tower into a higher region of the same absorption tower, specifically preferably downstream of a conveying device arranged in this riser conduit.

### BRIEF DESCRIPTION OF THE DRAWING

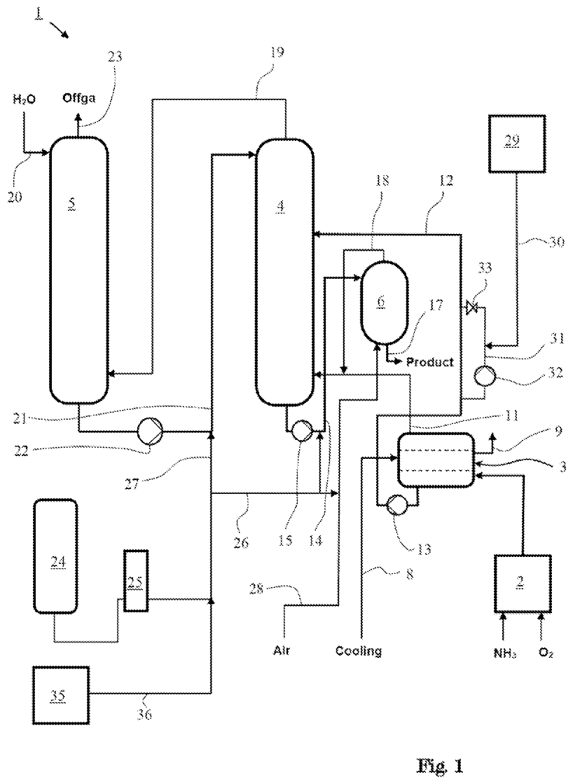

An exemplary embodiment of the invention shall be described in more detail on the basis of the drawing. The sole drawing (FIG. 1) schematically shows a connection diagram of a production plant according to the invention for preparing nitric acid.

### DETAILED DESCRIPTION

The production plant 1 shown in FIG. 1 for preparing nitric acid comprises, in a manner known per se, an ammonia combustion plant 2, a condenser 3, a plurality of, in the exemplary embodiment two, absorption towers 4, 5, and a bleaching column 6 The absorption towers 4, 5 in the exemplary embodiment are low- and medium-pressure columns that operate at an operating pressure of from 2 to 5 bar(g); however, medium-pressure or high-pressure columns with an operating pressure of up to 15 bar(g) may also be used.

The ammonia combustion plant 2 serves to react gaseous ammonia and oxygen at a temperature of between 600° C. and 900° C. over a gauze catalyst made from a noble metal, such as for example platinum or a platinum/rhodium alloy, to give nitrogen monoxide and steam. As oxygen, atmospheric oxygen is typically used. The reaction products of the reaction taking place in the ammonia combustion plant 2, essentially nitrogen monoxide and steam, and also excess oxygen, are supplied to the condenser 3 in which the reaction products are cooled by indirect thermal contact with a cooling medium, for example water or liquefied or cold gaseous nitrogen, conveyed via a cooling medium supply conduit 8, to a temperature at which at least some of the steam condenses, for example to 60° C. to 80° C. The cooling medium heated in the heat exchange is discharged via a cooling medium discharge conduit 9 and released to atmosphere or sent for another use. Some of the nitrogen oxides react with the water to give nitric acid, which settles at the base of the condenser 3 in an aqueous solution. The gas mixture present in the condenser 3 is introduced as process gas into a lower region of the absorption tower 4 via a gas supply conduit 11. Some of the nitrogen monoxide is oxidized with excess oxygen to give nitrogen dioxide and the dimer thereof dinitrogen tetraoxide. The aqueous, nitric acid-containing solution from the base of the condenser 3 is supplied via a connection conduit 12 to a region of the absorption tower 4 that is higher in relation to the mouth of the gas supply conduit 11. If the connection conduit 12 is a riser conduit, a conveying device 13 provides the pressure necessary to overcome the hydrostatic pressure.

The aqueous, nitric acid-containing solution from the condenser 3 is sprayed into the absorption tower 4 by means of a nozzle arrangement (not explained in more detail here), falls downwards and in the process comes into contact with the nitrogen oxide-containing process gases rising from the below. Further proportions of the nitrogen oxides present in the gas mixture react here to give nitric acid, which accumulates in an aqueous solution at the bottom of the absorption tower 4. This aqueous, nitric acid-containing solution is discharged via a conduit 14, transported by means of a conveying device 15 to the bleaching column 6, and sprayed therein. In turn, a nitrogen oxide-containing gas is formed in the bleaching column 6 and is introduced via a conduit 18 into the gas supply conduit 11 and via the latter into the absorption tower 4. The product, the bleached acid, is conducted away via conduit 17.

The nitrogen oxide-containing gas mixture remaining in the absorption tower 4 is discharged via a process gas conduit 19 and introduced into a lower region of the absorption tower 5. At the same time, water is sprayed from a water supply conduit 20 into the headspace of the absorption tower 5. The nitrogen oxide-containing gas mixture rising from below comes into contact in the absorption tower 5 with the water sprayed in and reacts at least in part with the latter to give nitric acid, which accumulates at the base of the absorption tower 5 in an aqueous solution. This aqueous, nitric acid-containing solution is discharged via a riser conduit 21 and conducted by means of a conveying device 22 to the headspace of the absorption tower 4, sprayed in there, and passes through the absorption tower 4 in countercurrent to the process gas stream to form increasingly highly concentrated nitric acid.

Gas mixture still present in the absorption tower 5 is discharged via an offgas conduit 23 and supplied to a unit (not shown here) for denoxing, in which the remaining nitrogen oxides are to a very great extent removed from the gas mixture.

For reasons of clarity, the exemplary embodiment shown in FIG. 1 only comprises two absorption towers 4, 5; of course, also conceivable in the context of the invention are exemplary embodiments comprising three or more absorption towers through which the nitrogen oxide-containing gas streams and the aqueous, nitric acid-containing solutions pass in countercurrent in a known way.

In order to intensify the oxidation of the nitrous gases and the nitrous acid, ozone is supplied to the process. The ozone is taken from a source for ozone which in the exemplary embodiment is an ozonizer 29 in which the ozone is produced on site from oxygen. The ozone from the ozonizer 29 is injected, together with oxygen still present, via an ozone supply conduit 30 into a bypass conduit 31 which branches off from the connection conduit 12 and opens back into it downstream of the mouth of the ozone supply conduit 30. In order to be able to achieve as high as possible a pressure in the region of the mouth of the ozone supply conduit 30, in the bypass conduit 31 a compressor 32 is arranged upstream thereof and a pressure reducer 33 is arranged downstream thereof, the latter reducing the pressure back down to the pressure prevailing in the connection conduit 12. In this way, a pressure of 10 bar(g) to 15 bar(g) or even higher can be achieved in the bypass conduit 31 in the region of the mouth of the ozone supply conduit 30, which promotes the dissolution of the ozone in the nitric acid-containing solution. Alternatively, the bypass conduit 31 can also open directly into the absorption tower 4.

In addition, in the exemplary embodiment shown here, oxygen is taken from an oxygen source, for example a tank 24, and introduced into the process. To this end, in a manner known per se, the oxygen passes through an air evaporator 25 and is supplied cold, but in gas form, via oxygen supply conduits 26, 27 to the conduit 14 and/or to the riser conduit 21 and/or to an air supply conduit 28 leading to the bleaching column 6. Instead of conversion to gas in an air evaporator 25, the cold content of the liquefied oxygen may furthermore also be used for cooling the reaction products from the ammonia combustion plant 2 in the condenser 3, for example by subjecting the cooling medium used there to a heat exchange with the liquid oxygen from the tank 24, or supplying the liquid oxygen from tank 24 directly to the condenser 3 as cold medium.

The oxygen conducted by the oxygen supply conduit 26 into the conduit 14 and/or into the air supply conduit 28 facilitates the oxidation of nitrogen oxides still present in the nitric acid and of the nitrous acid. An oxygen-rich gas phase accumulates in the headspace of the bleaching column 6 and is taken off via conduit 18 and combined with the gas mixture conducted through the gas supply conduit 11 from the condenser 3.

Instead of oxygen, ozone or an ozone-containing gas mixture may furthermore also be used, this being generated in an ozonizer 35 and injected via an ozone supply conduit 36 into at least one of the conduits 14, 21, 28.

In the riser conduit 21 and in the conduits 12, 14, if these are also riser conduits, the oxygen or the ozone of the ozone-containing gas mixture is preferably introduced in a geodetically lower region downstream of the respective conveying device 13, 15, 22, 32, in order to make use of the hydrostatic pressure of the liquid column in the conduit 12, 14, 21 and possibly of an additional pressure generated by the respective conveying device 13, 15, 22, 32. Within the section of the conduits 12, 14, 21 that adjoins downstream of the introduction point for the oxygen or the ozone, the oxygen or the ozone partially dissolves and reacts with nitrogen oxides that are dissolved in the nitric acid-containing solution, and possibly with water. Some of the oxygen introduced in excess and ozone decomposing into oxygen, if there is any, does not react with the nitrogen oxides and passes in gas form into the respective absorption tower 4, 5, where it results in a higher oxygen partial pressure which in turn promotes the formation of nitric acid in the respective absorption tower 4, 5. The formation of nitric acid is additionally facilitated by the low temperature of the oxygen or ozone supplied.

The invention is in particular also suitable for retrofitting existing plants which typically operate with absorption towers having an operating pressure that lies in the low- and medium-pressure region, i.e. at about 1 to 5 bar(g). The objective invention is, however, also usable for retrofitting high-pressure and dual-pressure plants. In this case, NOₓ concentrations in the offgas that are much lower still could even be achieved, as a result of which the operating costs of denoxing plants could be markedly reduced or the use of same might even be avoided entirely. This can result in substantial cost savings by saving on ammonia and/or natural gas, these typically being used as reducing agent for the denoxing.

### LIST OF REFERENCE SIGNS

1. Production plant
2. Ammonia combustion plant
3. Condenser
4. Absorption tower
5. Absorption tower
6. Bleaching column
7. —
8. Cooling medium supply conduit
9. Cooling medium discharge conduit
10. —
11. Gas supply conduit
12. Connection conduit
13. Conveying device
14. Conduit
15. Conveying device
16. —
17. Product discharge conduit
18. Conduit
19. Process gas conduit
20. Water supply conduit
21. Riser conduit
22. Conveying device
23. Offgas conduit
24. Tank
25. Air evaporator
26. Oxygen conduit
27. Oxygen conduit
28. Air supply conduit
29. Ozonizer
30. Ozone supply conduit
31. Bypass conduit
32. Compressor
33. Pressure reducer
34. —
35. Ozonizer
36. Ozone supply conduit

1. A process for preparing nitric acid, in which:
a. ammonia is reacted with oxygen to give nitrogen oxides and steam in an ammonia combustion plant;
b. the nitrogen oxides and the steam from step (a.) are cooled in a condenser to a temperature at which at least some of the steam condenses, with the nitrogen oxides in part reacting with the condensed steam and oxygen to give an aqueous, nitric acid-containing solution and in part remaining in a nitrogen oxide-containing gas mixture;
c. the nitric acid-containing solution from step (b.) is supplied from the condenser via a connection conduit to a first absorption tower;
d. the nitrogen oxide-containing gas mixture from step (b.) is supplied to the first absorption tower, in which it is brought into contact with water or with an aqueous solution, with the nitrogen oxide-containing gas mixture reacting with water at least in part to form an aqueous, nitric acid-containing solution which, together with the nitric acid-containing solution from step (c.), accumulates at the base of the first absorption tower; and
e. ozone is introduced into the nitric acid-containing solution from step (b.) conducted through the connection conduit prior to the supply thereof to the first absorption tower.

2. The process as claimed in claim 1, wherein the nitrogen oxide-containing gas mixture, after having passed through the first absorption tower, is supplied to a second absorption tower in which the nitrogen oxide-containing gas mixture is brought into contact with water or with an aqueous nitric acid-containing solution nitric acid solution, with the nitrogen oxide-containing gas mixture reacting at least in part to form a nitric acid-containing solution which accumulates at the base of the second absorption tower and from there is supplied to an upper region of the first absorption tower via a riser conduit, wherein ozone and/or oxygen is introduced into the nitric acid-containing solution conducted through the riser conduit.

3. The process as claimed in claim 1, wherein nitric acid-containing solution is discharged from the base of the first absorption tower and supplied via a conveying conduit to an upper region of the first absorption tower and/or to a bleaching column, wherein ozone and/or oxygen is introduced into the nitric acid-containing solution conducted through the connection conduit.

4. The process as claimed in claim 1, wherein the connection conduit is in the form of a riser conduit and the ozone and/or the oxygen is introduced downstream of a conveying device arranged in the connection conduit, in a geodetically lower region of the respective connection conduit.

5. The process as claimed in claim 3, wherein a substream is branched off from the nitric acid-containing solution conducted through the riser conduit, is compressed and is enriched with ozone and/or oxygen before being supplied to the absorption tower or the bleaching column.

6. The process as claimed in claim 1, wherein the ozone injected into the nitric acid-containing solution in the connection conduit has a temperature of below 10° C., preferably below 0° C.

7. A production plant for preparing nitric acid, the production plant comprising:
an ammonia combustion plant for reacting ammonia with oxygen to give nitrogen oxides and steam;
a condenser connected to the ammonia combustion plant for cooling the reaction products from the ammonia combustion plant to a temperature at which at least some of the reaction products condense;
a first absorption tower arranged downstream of the condenser for scrubbing the gas mixture formed in the condenser with water or with an aqueous nitric acid solution;
at least one riser conduit, leading from the condenser to the first absorption tower and equipped with a conveying device, for introducing a nitric acid-containing solution into the first absorption tower; and
a conveying conduit connecting the first absorption tower to a bleaching column;
wherein the riser conduit running between the condenser and the first absorption tower is connected in terms of flow via an ozone supply conduit to a source for ozone.

8. The production plant as claimed in claim 7, wherein the riser conduit is equipped with a bypass conduit into which the ozone supply conduit opens.

9. The production plant as claimed in claim 8, wherein means for compressing the nitric acid-containing solution are provided in the riser conduit and/or the bypass conduit at least in the region of the mouth of the ozone supply conduit.

10. The production plant as claimed in claim 7, wherein a conduit is provided, which leads from the bottom of the first absorption tower into a higher region of the first absorption tower and/or into a bleaching column and into which opens a supply conduit that is connected in terms of flow to an additional source for ozone and/or a source for oxygen.

11. The production plant as claimed in claim 7, wherein at least one second absorption tower is connected downstream of the first absorption tower and is connected to same via a riser conduit leading from the base of the second absorption tower to a headspace of the first absorption tower, wherein a supply conduit that is connected in terms of flow to an additional source for ozone and/or a source for oxygen opens into the riser conduit.
